(19) United States
(12) Patent Application Publication
(10) Pub. No.: US 2017/0187487 A1
(43) Pub. Date: Jun. 29, 2017

(54) METHOD FOR RATE INDICATION

(71) Applicant: MediaTek Singapore Pte. Ltd., Singapore (SG)

(72) Inventors: James June-Ming Wang, San Marino, CA (US); Kai-Chun Chou, Taipei City (TW); Ching-Hwa Yu, Tainan City (TW); Hsuan-Yu Liu, Hsinchu County (TW); Chih-Shi Yee, Hsinchu County (TW)

(21) Appl. No.: 15/313,550

(22) PCT Filed: May 27, 2015
(86) PCT No.: PCT/SG2015/050127

§ 371 Date: Nov. 22, 2016

Related U.S. Application Data
(60) Provisional application No. 62/003,245, filed on May 27, 2014.

(51) Int. Cl. H04L 1/00; H04L 5/14

(52) U.S. Cl. CPC H04L 1/0013; H04L 1/0067; H04L 5/1446; H04L 1/0002; H04L 1/0023; H04L 1/0059; H04L 1/0061

(57) ABSTRACT

A method to indicate a rate is proposed. In this method, a first wireless device determines a rate indicator and then transmits a packet including the rate indicator to a second wireless device. In one embodiment, the rate indicator can be determined by the first wireless device. In another embodiment, the second wireless device can suggest a rate and send it to the first wireless device.

### CROSS REFERENCE TO RELATED APPLICATIONS

This application claims priority under 35 U.S.C. §119 from U.S. Provisional Application No. 62/003,245 entitled “Symbol Rate Indication and Fast Adaptation for Long Range,” filed on May 27, 2014, the subject matter of which is incorporated herein by reference.

### TECHNICAL FIELD

The disclosed embodiments relate generally to Bluetooth communications, and, more particularly, to rate indication in Bluetooth communications.

### BACKGROUND

Bluetooth is a wireless technology standard for exchanging data over short distances (using the ISM band from 2.4 to 2.485 GHz) from fixed or mobile devices, and building personal area networks (PANs), as shown in FIG. 1(A). However, recent development in long range (LR) Bluetooth has extended the coverage of Bluetooth communications.

In long range communications, the long range channel characteristics is considerably different from short range. For example, long range communication has low signal-to-noise ratio (SNR) and more channel variations, since the channel condition may change a lot along the signal propagation path. Besides, frequency selective fading also happens to long range Bluetooth communication. Hopping channels may have significant difference in SNRs, so it is difficult to find a proper hopping sequence/channel map satisfying all nodes within the piconet of the Bluetooth communication. Channel-by-channel link management is needed to enhance the performance.

During the transmission, longer packet length is more susceptible to mid-packet collisions, and thus needs trickier link manager operation. But inadequate link management may lead to high power consumption.

Conventionally, Channel Quality Driven Data Rate Change (CQDDR) is used for Link Manager for symbol link adaptation. However, CQDDR has a slow adaptation because it needs the receiver to first detect channel degradation and then request a preferred rate. The transmitter switches to a preferred rate according to the request from the receiver. And it is difficult to adapt properly in the aforementioned low SNR and changing channel conditions, and it is also difficult to implement channel-by-channel symbol rate adaptation. Moreover, QOS and power consumption can be impacted by slow adaptation.

FIG. 1(B) illustrates a conventional packet 100 used in a Bluetooth communications system. A conventional Bluetooth receiver can receive the packet 100 with a Manchester matched filter. But the transmitter and the receiver need to negotiate the rate before transmitting any data and therefore consumes much time. Hence, there is a need for a solution for indicating a symbol rate.

### SUMMARY

It is therefore an object of the present invention to provide a method of wireless communication system. In this method, a first wireless device determines a rate indicator and then transmits a packet including the rate indicator to a second wireless device.

In one embodiment, the first wireless device and the second wireless device are Bluetooth devices.

In another example, the first wireless device receives another packet from the second wireless device, wherein the packet from the second wireless device includes a different rate indicator.

In another embodiment, a second wireless device receives a packet from a first wireless device. The packet includes a first part and a second part, and the first part includes a rate indicator. The second wireless device then decodes the second part according to the rate indicator.

Other embodiments and advantages are described in the detailed description below. This summary does not purport to define the invention. The invention is defined by the claims.

### BRIEF DESCRIPTION OF THE DRAWINGS

FIG. 1(A) illustrates a Bluetooth communication system.

FIG. 1(B) (Prior Art) illustrates a conventional packet used in Bluetooth communication.

FIG. 2 illustrates a packet in accordance with one novel aspect.

FIG. 3 illustrates a packet in accordance with another novel aspect.

FIG. 4 illustrates a packet in accordance with yet another novel aspect.

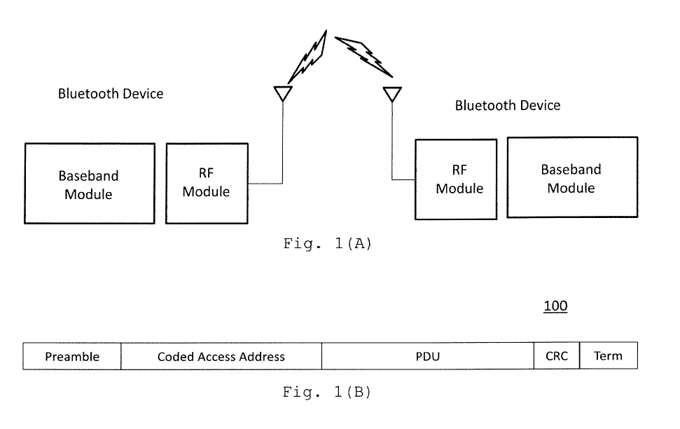

### DETAILED DESCRIPTION

Reference will now be made in detail to some embodiments of the invention, examples of which are illustrated in the accompanying drawings.

According to an embodiment of the present invention, a rate indicator (RI) is included in the long range (LR) signal transmitted by a first wireless device (e.g. a transmitter) to a second wireless device (e.g. a receiver). When the receiver receives the LR signal, the receiver can decode the rate indicator before data payload and obtain the rate information of the data payload. The receiver can then change the rate according to the rate indicator. Therefore, no handshake/synchronization is required for symbol rate change.

The rate indicator can be determined in several ways. For example, the transmitter can detect the channel condition and determine the rate and set a rate indicator. Or, the receiver can suggest a rate to the transmitter. However, the transmitter may determine whether to use the suggested rate. However, any other methods used to determine the rate indicator can be used and is not limited to the examples given herein.

The receiver can use the link management protocol message to recommend a data rate to the transmitter (in a PDU send from receiver back to transmitter). The transmitter can either accept the receiver recommendation or make decision on its own for the PDU to be transmitted based on its channel state information or the response of the receiver. In a preferred embodiment, the rate indicator takes precedence over the recommendation from receiver via the message in the link management protocol. The rate indicator can be included in the packet sent from a first wireless device to a second wireless device or vice versa. So both devices can adapt the symbol rate independently in the direction from the first wireless device to the second wireless device or in the direction from the second wireless device to the first wireless device.

Since the rate indicator is included in the long range packet, the rate can be adapted with hopping channels. So channel-by-channel adaptation becomes feasible.

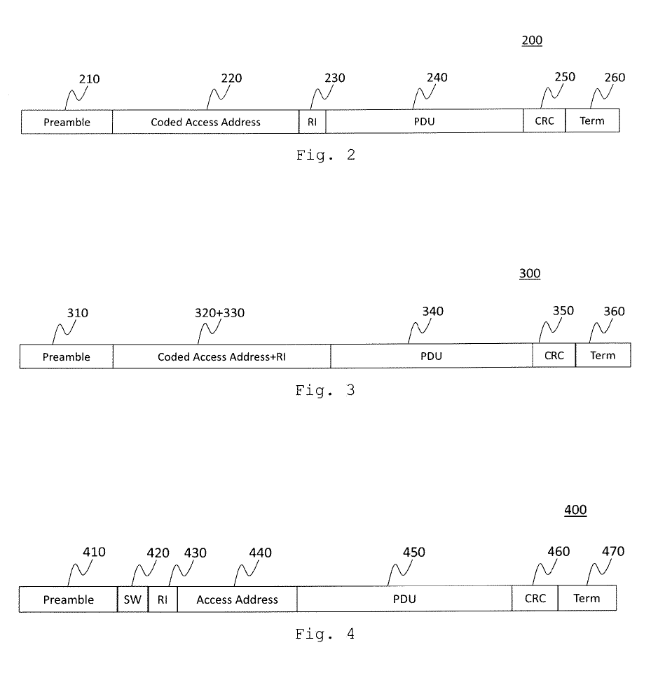

FIG. 2 illustrates a packet 200 used by a Bluetooth transmitter according to an embodiment of the present invention. The packet 200 includes a preamble field 210, an access address field 220, a rate indicator (RI) field 230, a protocol data unit (PDU) field 240, a cyclic redundancy check (CRC) field 250, and a term field 260.

According to an embodiment of the present invention, the preamble field 210 includes a sequence that is long enough to operate a 0 dB SNR, and allow multiplier receiver architectures. The access address 220 uses a pattern that is known in advance to the receiver, and can be coded with full protection. The PDU field, CRC field and the term field can use inner pattern or direct bit mapping and is forward error correction (FEC) coded.

When a transmitter transmits the packet 200 with the rate indicator 230, the transmitter can use the rate indicator field to indicate the rate of the PDU payload. According to an embodiment of the present invention, the bits in the access address field 220 and the rate indicator field 230 are first coded into convolutional coded bits and then transferred into Manchester symbols, while the length of each Manchester symbol can be, for example, 8 micro seconds.

Since the rate indicator 230 is arranged after the access address field 220, it allows a longer packet duration and has more reliable coded access address detection. For example, when a receiver receives the packet 200, the receiver first detects the preamble. After that, the receiver uses the lowest rate to decode the access address field 220 and the rate indicator field 230. After the receiver extracts the rate included in the rate indicator field 230, the receiver can use the rate in the rate indicator field 230 to decode the rest fields, such as the PDU field 240, CRC field 250 and Term field 260. According to an embodiment of the present invention, the access address 220 and the rate indicator 230 can be protected by a first forward error correction block, while the PDU field 240, CRC field 250 and Term field 260 are protected using a second forward error correction block.

Therefore, the transmitter can inform the receiver about the code rate within the packet and thus reduce the additional handshaking steps in the conventional method.

Now please refer to FIG. 3, which illustrates another packet 300 that can be used by a Bluetooth transmitter according to another embodiment of the present invention.

The packet 300 includes a preamble field 310, an access address field 320 that includes a rate indicator (RI) 330, a protocol data unit (PDU) field 340, a cyclic redundancy check (CRC) field 350, and a term field 360. The fields can have the similar functions as in the previous embodiment.

Since the rate indicator 330 is arranged within the access address field 320, when a receiver receives the packet 300, the receiver can allow a longer packet duration and has more reliable coded access address detection. Moreover, after the receiver extracts the rate included in the rate indicator field 330 while decodes the access address field 320, the receiver can use the rate in the rate indicator field 330 to decode the rest fields, such as the PDU field 340, CRC field 350 and Term field 360.

Now please refer to FIG. 4, which illustrates another packet 400 that can be used by a Bluetooth transmitter according to another embodiment of the present invention.

The packet 400 includes a preamble field 410, a sync word field 420, a rate indicator (RI) field 430, an access address field 440, a protocol data unit (PDU) field 450, a cyclic redundancy check (CRC) field 460, and a term field 470. The sync word field 420 is used for the detection of the end of preamble 410. Other fields can have the similar functions as in the previous embodiment.

Since the rate indicator 430 is arranged before the access address field 440 and after the sync word field 420, there is a shorter packet duration. Moreover, when a receiver receives the packet 400, the receiver can extract the rate included in the rate indicator field 430. Then the receiver can use the rate in the rate indicator field 430 to receive rest fields, such as the access address field 440, PDU field 450, CRC field 460 and Term field 470.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A method comprising,
determining a rate indicator by a first wireless device; and
transmitting to a second wireless device by the first wireless device a packet including the rate indicator;
wherein the packet includes a first part and a second part, and the second part is encoded according to the rate indicator.

2. The method of claim 1, wherein the step of determining a rate indicator comprises,
receiving a rate from the second wireless device with a link management protocol message; and
determining the rate indicator according to the rate.

3. The method of claim 1, wherein the step of determining a rate indicator comprises,
detecting a channel condition by the first wireless device;
determining a rate according to the channel condition; and
setting the rate indicator according to the rate.

4. The method of claim 1, wherein the first wireless device is a Bluetooth device.

5. The method of claim 1, wherein the first part includes a preamble, an access address field and the rate indicator.

6. The method of claim 5, wherein the rate indicator is included in the access address field.

7. The method of claim 6, wherein the first part includes a preamble, a sync word field and the rate indicator.

8. The method of claim 1, further comprising, receiving by the first wireless device another packet from the second wireless device, wherein the packet from the second wireless device includes a different rate indicator.

9. A method comprising,
receiving by a second wireless device a packet from a first wireless device, wherein the packet includes a first part and a second part, and the first part includes a rate indicator; and
decoding by the second wireless device the second part according to the rate indicator.

10. The method of claim 9, further comprising,
detecting a channel condition by the second wireless device; and
determining a suggested rate according to the channel condition; and
sending the suggested rate by the second wireless device to the first wireless device with a link management protocol message.

11. The method of claim 9, wherein the first wireless device and the second wireless device are Bluetooth devices.

12. The method of claim 9, wherein the first part includes a preamble, an access address field and the rate indicator.

13. The method of claim 12, wherein the rate indicator is included in the access address field.

14. The method of claim 9, wherein the first part includes a preamble, a sync word field and the rate indicator.
